(19) United States
(12) Patent Application Publication
(10) Pub. No.: US 2007/0083885 A1
(43) Pub. Date: Apr. 12, 2007

(54) On-line process for bidding on advertising spots

(76) Inventor: Michael T. Harding, Panama City, FL (US)

Correspondence Address: PILLSBURY WINTHROP SHAW PITTMAN, LLP, P.O. BOX 10500, MCLEAN, VA, 22102, US

(21) Appl. No.: 11/528,553

(22) Filed: Sep. 28, 2006

Related U.S. Application Data
(60) Provisional application No. 60/721,577, filed on Sep. 29, 2005.
(60) Provisional application No. 60/722,010, filed on Sep. 30, 2005.

(51) Int. Cl. H04N 7/10; H04N 7/025

(52) U.S. Cl. 725/34; 725/35; 725/32

(57) ABSTRACT

A method for buying and/or selling advertising spots electronically is provided. Buyers (agencies) may enter requests describing a desired advertising spot, and the requests may be correlated and/or filtered against available inventory posted by sellers (stations). A station may be notified of a request to and may respond by offering to sell an advertising spot corresponding to the request. In various implementations, agencies may accept, decline, or counter-offer the offer, or an application may automatically process an agency response to the offer. The method may be practiced in scatter markets and/or up-front advertising markets.

### CROSS-REFERENCE TO RELATED APPLICATIONS

This application claims the benefit of provisional U.S. Patent Application Ser. No. 60/721,577, entitled “On-Line Process for Bidding on Advertising Spots,” filed Sep. 29, 2005; and provisional U.S. patent application Ser. No. 60/722,010, entitled “On-Line Process for Bidding on Advertising Spots,” filed Sep. 30, 2005, both of which are hereby incorporated by reference in their entirety.

### BACKGROUND OF THE INVENTION

Typically, when a buyer, such as an advertising agency or a direct retailer, seeks to purchase advertising spots or air time in a television market, the procedure involves contacting sellers, such as TV stations or other sellers of advertising time, via telephone, email and/or facsimile to request inventory and terms, such as price, in the desired market. This is known as a “push” system from the perspective of sellers of advertising time and is a more typical arrangement at the agency level. Seller representatives may also solicit advertisers via telephone, email and/or facsimile to “pull” advertisers to their medium by purporting to offer competitive terms for advertising spots. The combined system is known as a push-pull system from the perspective of the sellers and is a more typical arrangement at the direct retailer level. For example, sellers may independently solicit potential buyers by fax and/or by email for advertising spots and the potential buyers may receive five, six, seven, or more pieces of correspondence for competing advertising slots.

The existing process of negotiating for advertising spots has the deficiencies of not being transparent or efficient, in addition to other deficiencies. Buyers must negotiate for inventory and terms without knowing what inventory is actually available and/or what terms the sellers would be willing to accept. Additionally, buyers negotiate without knowing a market value, which may be derived, for example, from terms that sellers have offered to or accepted from other buyers for the same or similar inventory. Without a system that enables competitive bidding for buyers of desired inventory, buyers cannot know if the offered terms are competitive or fair. Furthermore, while several options may be considered during a transaction between sophisticated negotiators, the negotiation process may be made more efficient by providing computers that support multiple concurrent transactions between the buyers and sellers.

In light of these and other problems, there is a need for a system for facilitating sales of advertising spots that benefit both advertising agencies and stations selling advertising spots.

### SUMMARY OF THE INVENTION

The invention addresses the aforementioned problems with the advertising market by proving an online venue where potential buyers of advertising spots (hereinafter “agency” or “agencies”) and sellers of advertising spots (hereinafter “station” or “stations”) can address their marketing and advertising needs. In one embodiment, a computer-implemented method for buying and selling advertising spots in an online scatter market is provided. In one embodiment, an agency may submit one or more requests for advertising spots. The requests may be submitted via an online submission form, or other forms. The request may include criteria describing a desired time, channel, date, or other criteria describing the desired advertising spot. In one embodiment, a station may respond to the requests by selecting one or more available advertising spots that are at least a partial match of criteria in the requests, and the station may generate an offer to sell the one or more available advertising spots. In one embodiment, the selection of at least one available advertising spot may be automated, or controlled at least partly by a user. In one embodiment, the agency may accept the offer in whole or in part, or the agency may decline the offer. If the agency declines the offer, the process may end, or if the agency accepts the offer in whole or in part, a transaction may be completed selling the at least one available advertising spot. An invoice may be generated to collect revenue from the agency for the station, or to collect a commission from the station.

In another aspect of the invention, advertising spots may be sold in an “upfront market.” The upfront process may include using a negotiation process lasting one or more rounds. An agency may submit one or more requests for desired advertising spots via an online submission form. A station may respond to one or more requests by selecting at least one available advertising spot that is at least a partial match for criteria in the one or more requests. An offer to sell the at least one advertising spot may be generated and transmitted to an agency that originated the requests. The agency may respond by accepting or declining the offer, or the agency may counter-offer the offer to sell the available advertising spots. The counter-offer may include one or more aspects of the offer, such as criteria describing the offered spots and/or a cost associated with the offered spots. The agency's response may then be transmitted to the station. If the agency declines the offer, the process may end. If the agency accepts the offer, a confirmation and invoice may be generated to process a transaction. If the agency counter-offers the offer, the station's counter-offer may be transmitted to the agency, where the station counter-offer may modify one or more aspects of the agency counter-offer. The agency may respond to the station's counter-offer by accepting, declining, or counter-offering, and the agency response may be transmitted back to the station. The negotiation process may last a predetermined number of rounds and/or until a predetermined expiration date and/or time is reached. Moreover, a negotiation round may be configured to expire after or at a predetermined time.

In one embodiment, available advertising spots posted by stations may be assigned a point value based on Nielsen ratings data. In another embodiment, agencies may submit requests that may include criteria describing a desired advertising spot. Agency requests may be correlated against station posted advertisements to identify one or more matches, and the matches may be filtered by comparing criteria in the requests against the available spots. The results of the filtering may be provided to the station. In another embodiment, an alert may be sent to one or more stations when a matching request is identified, where the alert may include criteria included within the matching request. In another embodiment, the alert may veil the request and certain information may be hidden from the station. If the station has available inventory corresponding at least in part to the matching request, the station may submit an offer to sell the inventory in response to the alert. In one embodiment, requests and available inventory are stored in a database. In another embodiment, agencies may enter requests and stations may post inventory using an online application. The online application may track agency and station activity to prepare invoices, analyze agency and/or station activity, or perform additional analysis.

Other objects and advantages of the invention will be apparent to those skilled in the art based on the following detailed description and accompanying drawings.

### BRIEF DESCRIPTION OF THE DRAWINGS

FIG. 1 is an exemplary system architecture according to one aspect of the invention;

FIG. 2 is an exemplary flow chart of a process for identifying advertising matches between buyers and sellers according to one aspect of the invention;

FIG. 3 is an exemplary flow chart of a process for executing a scatter market transaction according to one aspect of the invention;

FIG. 4 is an exemplary flow chart of a process for executing an upfront market transaction according to one aspect of the invention;

### DETAILED DESCRIPTION OF THE INVENTION

The invention provides a system and method for obtaining a competitive overview of advertising spots (avails) in markets including television, radio, newspapers, magazines, outdoor billboard advertising, internet advertising, or other markets. Markets are broadly defined herein to include any media that enables buying and/or selling. According to one embodiment of the invention, a station-initiated process for offering advertising spots in scatter markets may be provided. For example, in a scatter market for television advertising spots, stations, such as television stations or other sellers of advertising spots, may post an inventory of available advertising spots for agencies to view and decide whether or not to purchase the inventory. In one embodiment, a scatter market may be a “last-minute” market, where advertising spots may be sold just prior to an air-time at a discounted rate. Those skilled in the art will recognize other implementations of a scatter market. The station-initiated process offers at least transparency for remaining inventory, where by knowing the available inventory, advertising agencies are able to formulate competitive bids using supply and demand information, among other indicators. The station-initiated process may provide other benefits.

According to another aspect of the invention, an agency-initiated process for negotiating advertising spots in scatter markets may be provided. For example, advertising agencies or other agencies may obtain access to last minute or time sensitive information associated with “last-minute” advertising spots at terms generally more favorable than if the advertising spots were negotiated and purchased in advance. Under the agency-initiated process, the station may decline to provide a listing of remaining inventory. The agency-initiated process offers at least transparency of identifying parties to the transaction. By knowing the identity of the agency, the station may quote different terms based on factors such as agency revenue, size, frequency of use, or other factors. Additionally, the agency-initiated process enables stations to refrain from posting remaining inventory so that terms of the advertising spots may be set just before the advertising spot is aired, based on supply and demand information known to the station, among other indicators. The agency-initiated process may provide other benefits to the station.

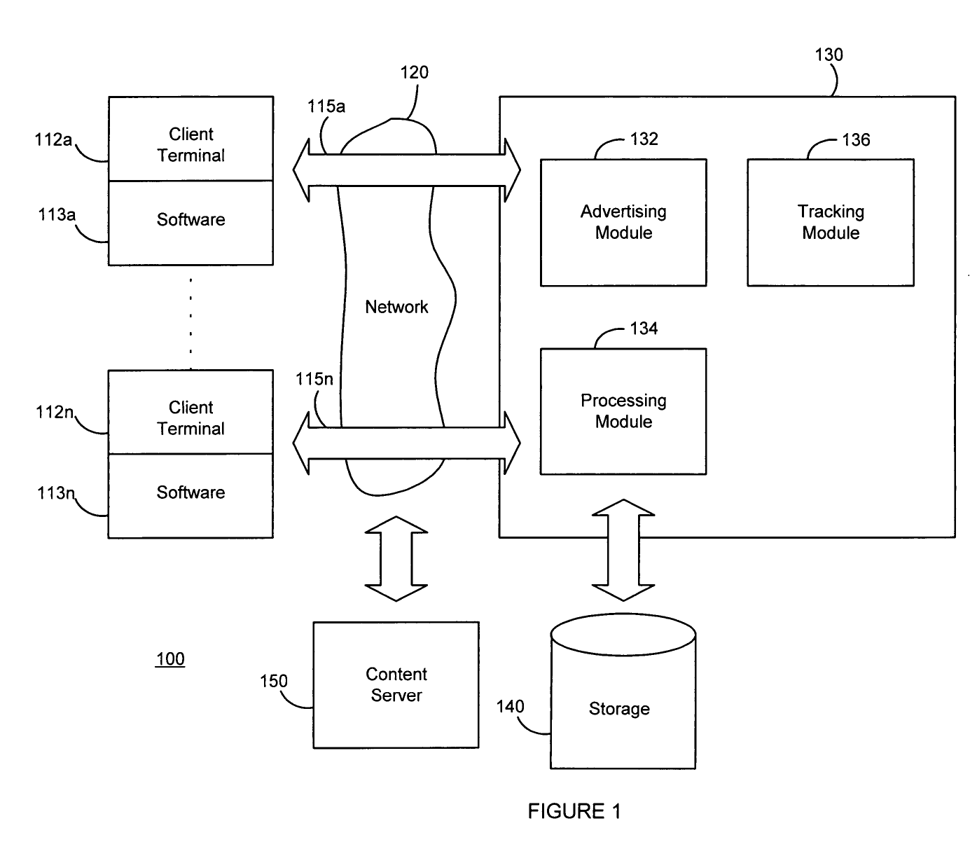

FIG. 1 illustrates a system architecture 100 according to one embodiment of the invention. Client terminals 112a-n (hereinafter identified collectively as 112) and server(s) 130 may be connected via a network 120, where network 120 may be a wireless, wired, or other type of network. Client terminals 112 may include any number of terminal devices including, for example, personal computers, laptops, PDAs, cell phones, Web TV systems, devices that combine the functionality of one or more of the foregoing or other terminal devices, and various other client terminal devices capable of performing the functions specified herein. According to one embodiment of the invention, users may be assigned to one or more client terminals 112a-n.

According to one embodiment of the invention, communications may be directed between one client terminal 112a and another client terminal 112n via network 120, such as the Internet. Client terminals 112a-n may communicate via communications media 115a-115n (hereinafter identified collectively as 115), respectively. Communications media 115 may be any wired and/or wireless media that enables network communications. Communications between respective client terminals 112 may occur substantially in real-time if the client terminals 112 are operating online. According to another embodiment of the invention, communications may be directed between client terminals 112 and content server(s) 150 via network 120. Client terminals 112 may communicate via communications media 115, such as, for example, any wired and/or wireless media. Communications between client terminals 112 and the content server 150 may occur substantially in real-time if the devices are operating online. Communications via network 120, such as the Internet, may be implemented using current and future language conventions and/or current and future communications protocols that are generally accepted and used for generating and/or transmitting messages over the network 120. Language conventions may include Hypertext Markup Language (“HTML”), extensible Markup Language (“XML”) and other language conventions. Communications protocols may include, Hypertext Transfer Protocol (“HTTP”), TCP/IP, SSL/TLS, FTP, GOPHER, and/or other protocols. Those skilled in the art will appreciate various ways of conducting communications among devices.

According to one embodiment of the invention, client terminals 112 may access, or be modified to access, corresponding software 113a-113n (hereinafter identified collectively as 113) that may operate to enable purchasing or selling of advertising spots for selected media using the corresponding client terminal 112. According to one embodiment of the invention, software 113 may include client-side software. According to another embodiment of the invention, software 113 may include server-side software, which may be accessed through an advertising module 132 residing on server 130. Communications between the client terminals 112 and server 130 may be communicated through a proxy server or other servers. Those skilled in the art will appreciate other configurations for deploying software 113.

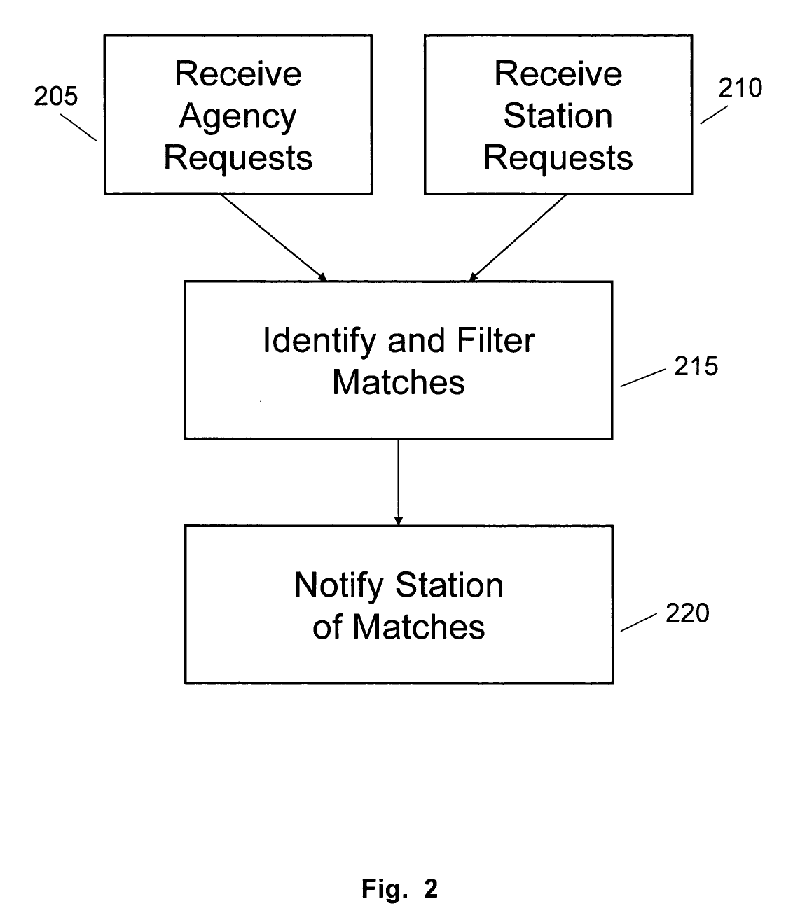

Referring to FIG. 2, an exemplary flow chart for matching buyers and sellers in an advertising market is provided according to one aspect of the invention. In one embodiment of the invention, one or more agencies and/or one or more stations may submit advertising transaction requests using an online application. The online application may provide an online submission form for agencies and/or buyers to request an advertising transaction, where the form may have fields for specifying criteria for the transaction.

In one implementation, an agency may submit a request for one or more advertising spots in an operation 205. The requests may include criteria describing an advertising spot that the agency would like to purchase. For example, the criteria may include an agency identifier, a market, an expiration date and/or time, a begin date, an end date, a day(s) of the week, actual Nielsen data, adjusted Nielsen data, demographic information, a duration, a point value, a cost, a budget, a daypart, a points per daypart, a percentage of points per day part, and/or a minimum rating per daypart. Those skilled in the art will recognize additional criteria and/or modifications to the above criteria as may be relevant to advertising markets.

In one implementation, a station may submit one or more available advertising spots in an operation 210. Operation 210 may enable stations to enter available advertising inventory and/or program schedules controlled, managed, and/or operated by the station. In one implementation, program schedules may be entered up to a year in advance. In another implementation, program schedules may be entered for a quarter (three months), and the quarterly program schedule may be copied to other quarters to reduce data entry requirements. In other implementations, smaller increments may be used to further reduce the data entry requirements. The program schedules may include criteria identifying an inventory of available and/or purchased advertising spots. For example, criteria for an advertising spot may include a station identifier, a program name, a time block, a start time, an end time, an air length, a program source, a default rate for a program, a starting bid, daypart codes, a run day, and/or a channel name. Those skilled in the art will recognize additional criteria and/or modifications to the above criteria as may be relevant to advertising markets.

In one implementation, data entry requirements may be reduced by automatically populating market data if the station is a Nielsen subscriber. Where the station is a Nielsen subscriber, a program name may be selected from a drop-down list. Those skilled in the art will recognize additional forms or techniques for presenting users with options for selecting program names. In another implementation, a station may manually enter the program name, description, and criteria. Each advertising spot may be associated with a point value or a ratings value corresponding to a number of viewers for a program in which the advertising spot is scheduled to air. For example, an advertising spots with a higher point value or ratings value may be assigned a higher cost because more viewers are likely to watch a program in which the advertising spots are scheduled.

After agencies have submitted requests for advertising spots in operation 205 and stations have submitted available inventory and/or program schedules in operation 210, the inventory and/or schedules may be stored in tables within a database. The database may collect advertising inventory for a plurality of stations across a plurality of markets. An operation 215 may then correlate criteria specified in the agency requests against the criteria describing available inventory and/or schedules to identify one or more matches.

In one implementation, operation 215 may determine whether criteria describing an available advertising spot at least partially matches criteria in an agency request, and operation 215 may select a predetermined number of closest matching available spots accordingly, and the predetermined number of closest matches may be subject to further processing. In one implementation, operation 215 may identify the predetermined number of matches by comparing Nielsen data associated with available advertising spots against Nielsen criteria specified in an agency request (e.g., actual and/or adjusted Nielsen data). When matches are identified, operation 215 may filter the matches according to a day of a week, a time of day, or other criteria. The filtered matches may return Nielsen data, and the returned Nielsen data may be used to verify that a station and/or market for the matches is correct. Markets may be defined according to Designated Market Areas (DMAs), as defined by Nielsen Media Research (e.g., there are two hundred ten DMAs in the United States). The returned Nielsen data may be in raw format, and the matches may be converted from a raw data format to a book ratings data format before verification. A conversion operation (e.g., an ARINC-developed VB.NET application, an automated script, or other computer-executable routine) may extract a comma delimited text file from the raw data. For example, raw Nielsen data may appear as follows:

“Q10600WPXIPITTSBURGH0004500021000440000900072000120004400054”

The conversion operation may extract a comma delimited text file from the raw Nielsen data as follows:

“Q1”, 0600, “WPXI”, “PITTSBURGH”, 4532, 2231, 4463, 3359, 73532, 3512, 44, 54.

The data in the comma delimited text file still includes raw Nielsen data, although the data is in a parsed form. The text file may therefore be further processed using Nielsen provided criteria specifying how to convert the data into a more meaningful form. In one implementation, the text file may be converted into another form using a script (e.g., a PERL/UNIX script), or the conversion operation may be configured to perform all conversions necessary to convert the raw data into book ratings format. For example, one or more variable names may be assigned to sections of the data in the comma delimited text file. For example, book ratings format may include a column for men aged 18-34, whereas raw data format may include a column for men aged 18-20, a column for men aged 21-24, and a column for men aged 25-34. Therefore, converting to book ratings format may include adding the columns for men aged 18-20, 21-24, and 25-34. All columns of the raw data in the comma delimited text file may be similarly converted into columns of book ratings data, which places the data in the correct data columns. In one implementation, the original raw Nielsen data may include a column specifying how to convert the raw data into book ratings data.

According to another aspect of the invention, the raw Nielsen data may be converted from 15-minute increments into 30-minute increments, where one data column contains time information. The time conversion may add one or more data rows with time information ending in either 15 or 45 to one or more data rows with time information ending in 00 or 30, and the total may be divided by 2. The converted times may be exported to a text file that may be imported or manually entered into a database. The raw data may finally be converted into book ratings format by multiplying an actual raw data rating by an actual HUT raw data rating, wherein a product of the multiplication may be divided by the actual HUT raw data to obtain an Actual Nielsen Rating. In another embodiment, a ratings-adjustment operation may multiply the actual raw data rating by an adjusted HUT raw data rating and a product of the multiplication may be divided by the adjusted HUT raw data rating to obtain an Adjusted Nielsen Rating. The Actual and Adjusted Nielsen Ratings may then be made available to a (e.g., by displaying the Ratings using a web browser or other user interface).

When one or more matches are identified, the matches may be filtered by determining whether Nielsen rating points associated with the matches are within budget constraints specified in agency requests. The matches may be further filtered by determining whether the Nielsen rating points associated with the matches remain within the budget constraints when added to previously selected and/or purchased advertising spots. If the identified matches pass the filters, the matches may be further filtered by determining whether daypart codes associated with the matches, or portions thereof, are correct. Furthermore, station information may be compared to station information for previously selected or sold advertising spots to evenly distribute advertising time purchased by an agency across a wider base of available stations, which may maximize an exposure of an agency advertisement. If an even spread cannot be provided, a random selection may disperse purchased advertising spots. After all possible selections are made fitting all filtered categories, unused money and/or ratings points may be used to randomly select one or more closest matches, which may be offered to an agency for possible purchase.

After one or more advertising spots in the database have been matched against one or more agency requests, the entries may be returned to a station selling the advertising spots in an operation 220. In one implementation, the matches may be returned to the station by an online application configured to broadcast alerts (e.g., via e-mail). Stations may subscribe to a service to receive the alerts, or the stations may access the online application to evaluate the matching agency requests. If no matching advertising spots are identified, a message may be displayed indicating that no matches were identified.

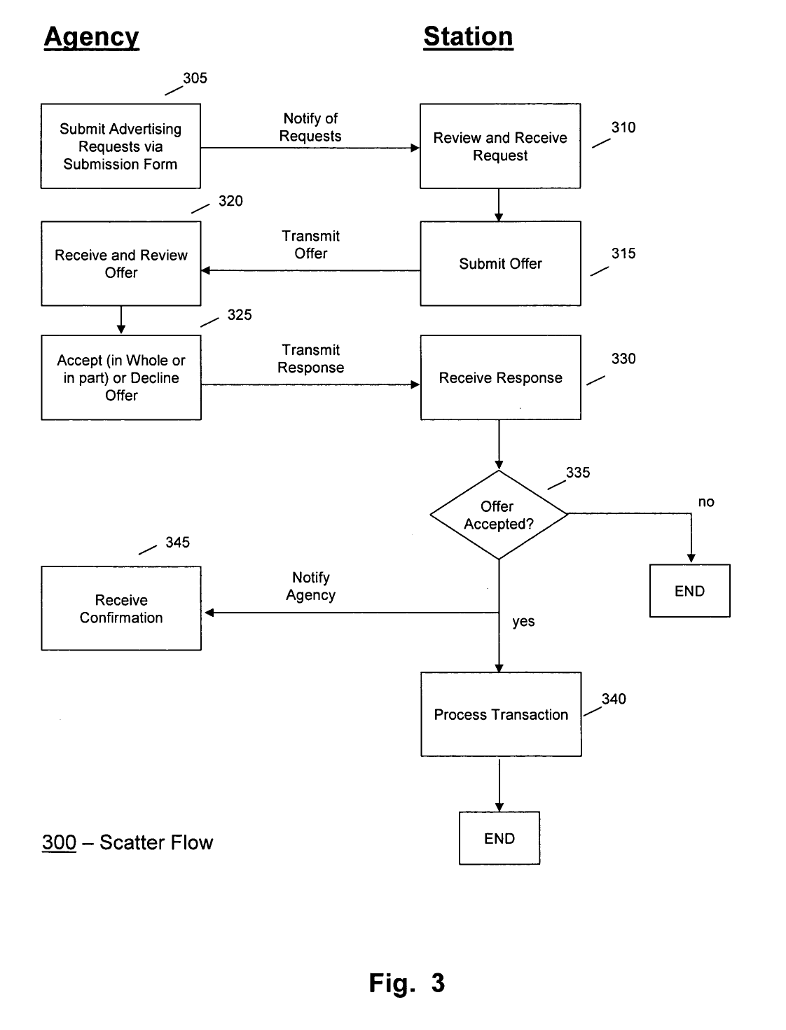

Referring to FIG. 3, an exemplary process 300 is provided for selling advertising spots in a “scatter market” according to one aspect of the invention. In a “scatter market,” stations may submit excess inventory of advertising spots at the last minute. The available inventory may be correlated against agency requests to buy advertising spots (e.g., according to the process of FIG. 2), and stations may obtain revenue from inventory that may otherwise remain unsold.

In one implementation, process 300 may facilitate advertising transactions in a “scatter market.” Time-sensitive buys of advertising spots in the scatter market may be based on matching criteria in agency requests against last-minute inventory submitted by stations. Process 300 may facilitate a transaction as a one-round process to minimize an amount of time required to complete a last-minute transaction.

In an operation 305, an agency may submit one or more requests to purchase advertising spots using an online application, where the requests may include criteria describing a desired advertising spot. In one implementation, agencies may provide different amounts of criteria when submitting the requests. For example, an agency may leave some criteria fields blank if the agency does not want to disclose a budget or if the agency wishes to have certain fields act as wildcards. In one implementation, the requests may include an expiration date and/or an expiration time. After the agency has submitted the requests, the online application may determine whether or not a station has posted advertising spots. If no advertising spots have been posted, the requests may pend until either advertising spots are posted, or the expiration date and/or time is reached. If advertising spots are posted, the agency requests may be correlated against the posted “scatter market” inventory, submitted by stations selling advertising time, and one or more closest matches may be identified (e.g., according to the process of FIG. 2). A notification may be sent to a station when the station has posted scatter inventory that is among the identified matches. In one implementation, matching agency requests may be distributed evenly (or as close to evenly as possible) among participating stations to fairly distribute requests. The notification may be an alert (e.g., an e-mail), and the notification may include criteria from the matches describing an advertising spot desired by the matching request. In another implementation, the notification may veil the match by hiding the criteria and request information. For example, the notification may include a number that identifies the request rather than an agency that submitted the request. Stations may then log into an online application and enter the number to view details of the request. Once logged-in, header information or other information including the agency information may then be displayed. When the station logs into the online application and enters the number to view the request, the application may track the station's activity (e.g., to assist in generating invoices or other actions).

In an operation 310, the notification of matching agency requests may be received and reviewed by the station. The station may elect to ignore the alert (e.g., if the agency's budget is below a desired revenue value), in which case the operation may end. In another implementation, the station may access the alert, and criteria describing an advertising spot desired by an agency may be displayed. The station may then review the requests to identify one or more requests that may be a potential match against available last-minute inventory. If the station reviews the request and corresponding criteria, and deems the request to be a potential candidate for a sale, the station may generate and/or submit an offer to sell the available advertising inventory to the requesting agency in an operation 315. In one implementation, the offer may contain criteria describing the available advertising inventory and/or a price to purchase the inventory. In one implementation, the price may be discounted to increase the likelihood of executing a transaction in the scatter market.

The offer may be transmitted to an agency, and the agency may receive and review the offer in an operation 320. In one implementation, the offer may be stored in a database and presented to the agency for selection. In another implementation, the offer may be presented to the agency for selection in a transient form, without being stored in the database. In an operation 325, the agency may take action by accepting the offer, in whole or in part, or by declining the offer. In another implementation, the agency may set a preference to automatically process the offer (e.g., the offer may be automatically accepted if an offered price is a predetermined amount below a budget constraint). If the agency elects to accept the offer in part, the agency may select one or more desired aspects of the criteria describing the available inventory. For example, the station may offer to sell three last-minute spots to the agency, and the agency may elect to accept the offer to sell two of the three spots.

The response to the offer may be transmitted to the station, and the response may indicate whether the offer was accepted, accepted in part, or declined. In an operation 330, the station may receive the response. The response may be processed in an operation 335, where if the response indicates that the offer was declined, the process ends and no further action is taken. The station may then optionally return to operation 310 to try to sell the available inventory again (e.g., by looking for other agency requests, lowering an offer price, etc.). If the offer is accepted, in whole or in part, the station may finalize a transaction to sell the offered advertising spot in an operation 340, and a notification that the transaction has been executed may be sent to the agency (e.g., the notification may send an e-mail to a traffic manager for the agency).

The agency may receive the notification in an operation 345, and the transaction may be processed. Processing the transaction may include, among other things, placing the spot in a shopping cart that includes a listing of accepted offers or generating an e-receipt describing one or more terms of the offer and/or acceptance. In another implementation, the notification may comprise an e-mail, and the e-mail may include a link enabling the agency to upload an advertising spot (e.g., standard graphical movie files such as .avi, mpg, or others) to an online application, where the uploaded advertising spot corresponds to the request that matured into the transaction. A notification (e.g., a e-mail) may also be sent to the station, and the notification may include a link to for the station to download the uploaded advertising spot directly into the station's broadcasting system. In another implementation, the notification e-mail (or a second notification e-mail) may be sent to the station when the agency has uploaded the advertising spot. This may facilitate scatter market transactions by substantially reducing the amount of time between completing a transaction and airing advertising spots.

In one implementation, tracking module 136 (see FIG. 1) may track process 300 to track a status of offers and/or responses to offers as they progress through the online application. The tracking may be performed in real-time or in time-delay by executing a refresh function at selected intervals. For example, the tracking module may track a number of offers received by the agency and/or station, a cost of the offers, what actions an agency and/or station takes at each stage of process 300, and/or other information. As a result, a user interface may be provided for displaying a status of a past or pending transaction. Tracking status enables agencies and/or stations to determine whether actions are required, if an offer should be resubmitted, or take other actions.

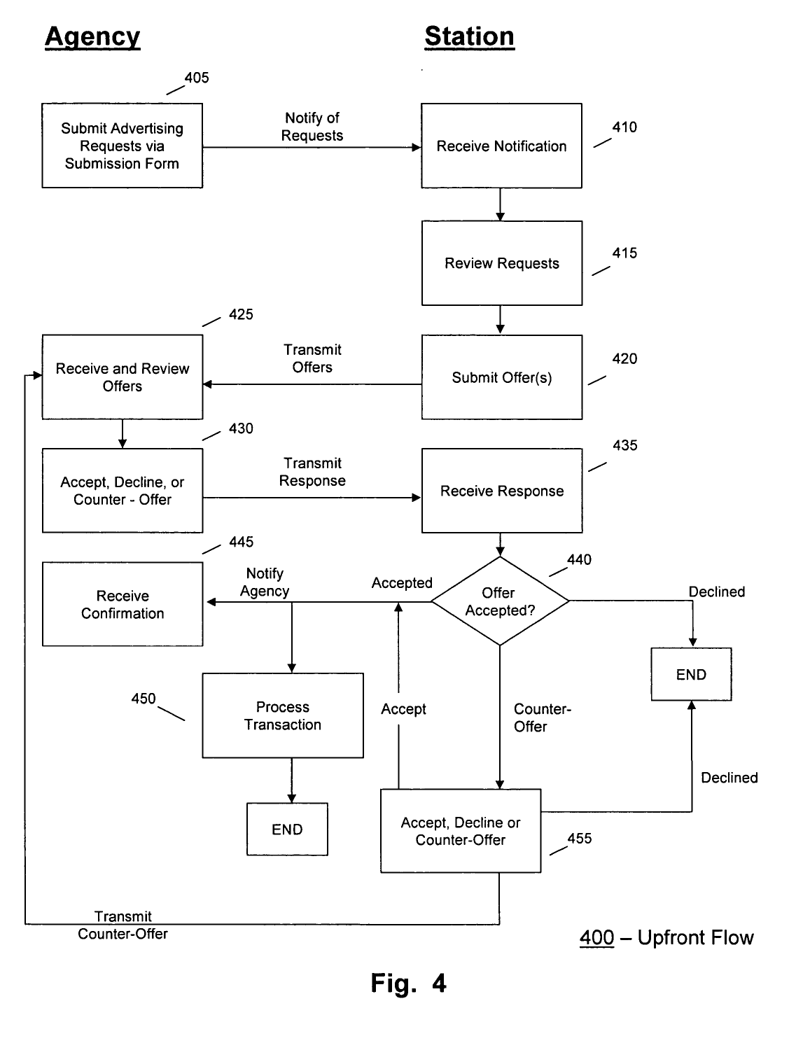

Referring to FIG. 4, an exemplary process 400 is provided for negotiating advertising spots in an “upfront market” according to one aspect of the invention. In an “upfront market,” stations may post available inventory of advertising spots in advance. For example, the invention may be used for pre-planned buying and/or selling of advertising spots for a year, quarter, month, or other time in advance of an air date of the advertising spots (e.g., stations may post available inventory in advance as described above in FIG. 2). The available inventory may be correlated against agency requests to buy advertising spots (e.g., according to the process of FIG. 2), and stations and agencies may engage in multi-round negotiations to enter into transactions for the available inventory. Process 400 may facilitate a transaction as a multi-round negotiation to optimize a bargain for agencies and/or sellers by enabling the agencies and sellers to reach mutually acceptable terms. In another implementation, a single round process may be used, where once an offer is rejected, the station must generate a new offer if the station wants to reattempt executing a transaction (in the case of a single-round process, the process flow is similar to that described in FIG. 3).

In an operation 405, an agency may submit one or more requests to purchase advertising spots using an online application, where the requests may include criteria describing a desired advertising spot. In one implementation, agencies may provide different amounts of criteria when submitting the requests. For example, an agency may leave some criteria fields blank if the agency does not want to disclose a budget or if the agency wishes to have certain fields act as wildcards. The agency requests may be correlated against “upfront market” inventory that is posted by stations selling advertising spots, and one or more closest matches may be identified (e.g., according to the process of FIG. 2). A notification may be sent to a station when the station has posted inventory that is among the identified matches. In one implementation, matching agency requests may be distributed evenly (or as close to evenly as possible) among participating stations to fairly distribute requests. The notification may be an alert (e.g., an e-mail), and the notification may include criteria from the matches describing an advertising spot desired by the matching request. In another implementation, the notification may veil the match by hiding the criteria and request information. For example, the notification may include a number that identifies the request rather than an agency that submitted the request. Stations may then log into an online application and enter the number to view details of the request. Once logged-in, header information or other information including the agency information may then be displayed. When the station logs into the online application and enters the number to view the request, the application may track the station's activity (e.g., to assist in generating invoices or other actions).

In an operation 410, the notification of matching agency requests may be received by the station. In an operation 415, the station may elect to ignore the alert (e.g., if the agency's budget is below a desired revenue value), in which case the operation may end. In another implementation, the station may access the alert in operation 415, and criteria describing an advertising spot desired by an agency may be displayed. The station may then review the requests to identify one or more requests that may be a potential match for available inventory. If the station reviews the request and corresponding criteria, and deems the request to be a potential candidate for a sale, the station may generate and/or submit an offer to sell the available advertising inventory to the requesting agency in an operation 420. In one implementation, the offer may include criteria describing the available advertising inventory, such as a price to purchase the inventory, a begin week, an end week, a number of weeks to run, a begin time, an end time, and/or other information.

The offer may be transmitted to an agency, and the agency may receive and review the offer in an operation 425. In one implementation, the offer may be stored in a database and presented to the agency for selection. In another implementation, the offer may be presented to the agency for selection in a transient form, without being stored in the database. In an operation 430, the agency may take action by accepting the offer, declining the offer, or making a counter-offer to the offer (e.g., within a “haggle zone”). In another implementation, the agency may set a preference to automatically process the offer (e.g., the offer may be automatically accepted if an offered price is a predetermined amount below a budget constraint). If the agency elects to make a counter-offer to the offer, the agency may select one or more desired aspects of the criteria describing the available inventory. For example, the station may offer to sell three spots to the agency, and the agency may elect to counter-offer to buy two of the three spots.

The response to the offer may be transmitted to the station, and the response may indicate whether the offer was accepted, counter-offered within the “haggle zone,” or declined. In an operation 435, the station may receive the response. The response may be processed in an operation 440, where if the response indicates that the offer was declined, the process ends and no further action is taken. The station may then optionally return to operations 410 and 415 to try to sell the available inventory again (e.g., by looking for other agency requests, lowering an offer price, etc.). If the offer is accepted, the station may finalize a transaction to sell the offered advertising spot in an operation 450, and a notification that the transaction has been executed may be sent to the agency (e.g., the notification may send an e-mail to a traffic manager for the agency).

The agency may receive the notification confirming the transaction in an operation 445, and the transaction may be processed in operation 450. Processing the transaction may include, among other things, placing the spot in a shopping cart that includes a listing of accepted offers or generating an e-receipt describing one or more terms of the offer and/or acceptance. In another implementation, the notification may comprise an e-mail, and the e-mail may include a link enabling the agency to upload an advertising spot (e.g., standard graphical movie files such as .avi, .mpg, or others) to an online application, where the uploaded advertising spot corresponds to the request that matured into the transaction. A notification (e.g., a e-mail) may also be sent to the station, and the notification may include a link to for the station to download the uploaded advertising spot directly into the station's broadcasting system. In another implementation, the notification e-mail (or a second notification e-mail) may be sent to the station when the agency has uploaded the advertising spot. This may ease upfront market transactions by substantially reducing a cost associated with an advertising transaction. For example, a cost of transferring electronic media (e.g., a digital file) to physical media (e.g., a videotape or CD-ROM) may be eliminated, and a time cost associated with mailing the physical media may also be eliminated.

If the agency response is a counter-offer within the haggle zone, processing may proceed to an operation 455 to begin a negotiation of one or more rounds. The agency and station may negotiate over various criteria of the offered advertising spots (e.g., the agency may desire an advertising spot with a higher rating) and/or terms of the offer (e.g., the agency may desire the advertising spot at a lower cost). In operation 455, stations may accept, decline, or counter-offer the counter-offer. If the station accepts the counter-offer, processing may proceed to operations 445 and 450, and the transaction may be completed in a similar manner as when the agency accepts the initial offer. In another implementation, the station may decline the counter-offer, in which case the process may end. If the station makes a counter-offer to the agency counter-offer, the counter-offer may be transmitted to the agency, and processing may return to operation 425, and processing continues from operation 425 as described above.

In one implementation of the invention, negotiation process 400 may be configured to last for a predetermined number of rounds and/or until an expiration deadline. In another implementation, a single negotiation round may be configured to automatically expire on a predetermined date and/or time. A deadline alert may notify an agency and/or station when a negotiation process and/or round is approaching an expiration date and/or time, thereby enabling parties to take any necessary actions to conclude a transaction. The deadline alert may apply to any operation within the negotiation process after the station has made an initial offer to an agency request in operation 420 and when a response is due (e.g., at decisional operations 430 and/or 455). The deadline alert may be configured to send a notification a predetermined amount of time before a negotiation round is set to expire. The deadline alert may be sent (e.g., via e-mail) at one or more designated critical times. For example, critical times may be defined as 2 hours 15 minutes, 1 hour 15 minutes, and/or 30 minutes before expiration. The deadline alert may be configured to send an e-mail notification to one or more personnel associated with the notified agency and/or station (e.g., the e-mail may be sent to a user involved in the negotiation, a sales manager, a general manager, and/or a site administrator). Those skilled in the art will appreciate that the critical times may be varied in one or more implementations, and the personnel notified of the deadline may be varied in one or more implementations (e.g., one person may be notified at the first critical time, two personnel may be notified at the second critical time, etc.).

In another implementation, tracking module 136 (see FIG. 1) may track process 400 to track a status of offers and/or responses to offers as they progress through the online application. The tracking may be performed in real-time or in time-delay by executing a refresh function at selected intervals. For example, the tracking module may track a number of offers (or counter-offers) received by the agency and/or station, a cost of the offers (or counter-offers), what actions an agency and/or station takes at each stage of process 400, and/or other information. As a result, a user interface may be provided for displaying a status of a past or pending transaction. Tracking status enables agencies and/or stations to determine whether actions are required, if an offer (or counter-offer) should be resubmitted, or take other actions.

According to another aspect of the invention, buyers and/or stations may cancel all or part of a transaction for one or more advertising spots using a post-transaction cancellation and makegood option. For example, stations, agencies, and/or clients of the stations and/or agencies may cut an advertising budget, or stations may bump one or more spots, necessitating cancellation of the transaction. In one implementation, if an advertising spot is cancelled, the agency may be credited for any portion of the spot that was cancelled. In another implementation, additional advertising spots may be provided to the agency if the station does not meet the agency's posted requirements for the transaction. A multi-round negotiation process may be used to determine a remedy for the agency and/or station in the event of full or partial cancellation. For example, an agency may prefer to have a subsequent advertising spot air in a higher rated program instead of receiving a credit.

The above disclosure has been described in terms of specific exemplary aspects, implementations, and embodiments of the invention. However, those skilled in the art will recognize various changes and modifications that may be made, and other components performing equivalent functions may be suitably substituted, without departing from the scope and spirit of the invention. Further, the methods of the invention may be achieved in either all software implementations, using the appropriate processor instructions, or in a combination that utilizes hardware logic and software logic to achieve the same results. Therefore, the specification and drawings are to be regarded as exemplary only, and the scope of the invention is to be determined solely by the appended claims.

What is claimed is:

1. A computer-implemented method for selling advertising spots, the method comprising:
receiving, from a buyer, at least one request to purchase an advertising spot, wherein the at least one requests includes criteria describing the requested spot;
receiving, from a seller, an inventory of at least one available advertising spot, wherein the inventory includes criteria describing the at least one available spot;
correlating the request criteria and the inventory criteria to identify at least one match;
receiving, from the buyer, an offer to purchase the at least one match; and
completing a transaction for the at least one match when a predetermined condition is met.

2. The method of claim 1, wherein the offer comprises a bid on the at least one match, the bid including criteria that modifies at least part of the criteria describing the at least one match.

3. The method of claim 2, further comprising at least one negotiation round, the negotiation round comprising:
receiving, from the seller, a response to the bid, wherein the response is one of an acceptance, a rejection, or a counter-offer to the bid; and
receiving, from the buyer, a response to the seller response, wherein the buyer response is one of an acceptance, a rejection, or a counter-offer to the seller response.

4. The method of claim 3, wherein the predetermined condition is met after a predetermined number negotiation rounds.

5. The method of claim 3, wherein the predetermined condition is an acceptance or a rejection of the buyer response.

6. The method of claim 3, wherein the predetermined condition is an acceptance or a rejection of the seller response.

7. The method of claim 3, wherein the predetermined condition is an expiration of the buyer and/or seller response.

8. A computer-implemented method for creating an online advertising marketplace where buyers and sellers are brought together based on common advertising needs, the method comprising:
receiving specifications for desired advertising spots from one or more buyers;
receiving postings of available advertising inventory from one or more sellers;
executing a comparison algorithm that compares the specifications for desired advertising spots with the postings of available advertising inventory, wherein the comparison algorithm generates a set of results;
making the set of results available to a buyer; and
enabling a buyer to purchase advertising inventory from a seller based on the buyer selecting at least one of the set of results.

9. The method of claim 8, further comprising:
sending an alert to at least one seller when a specification for desired advertising spots is received; and
enabling the at least one seller to submit available advertising inventory that matches the specification in response to the alert.

10. The method of claim 8, wherein buyers enter specifications and sellers enter submissions into an online application.

11. A system for selling advertising spots online, the system comprising one or more processing devices collectively configured to:
receive, from a buyer, at least one request to purchase an advertising spot, wherein the at least one requests includes criteria describing the requested spot;
receive, from a seller, an inventory of at least one available advertising spot, wherein the inventory includes criteria describing the at least one available spot;
correlate the request criteria and the inventory criteria to identify at least one match;
receive, from the buyer, an offer to purchase the at least one match; and
complete a transaction for the at least one match when a predetermined condition is met.

12. The system of claim 11, wherein the offer comprises a bid on the at least one match, the bid including criteria that modifies at least part of the criteria describing the at least one match.

13. The system of claim 12, the one or more processing devices further collectively configured to process at least one negotiation round, the negotiation round comprising the steps of:
receiving, from the seller, a response to the bid, wherein the response is one of an acceptance, a rejection, or a counter-offer to the bid; and
receiving, from the buyer, a response to the seller response, wherein the buyer response is one of an acceptance, a rejection, or a counter-offer to the seller response.

14. The system of claim 13, wherein the predetermined condition is met after a predetermined number negotiation rounds.

15. The system of claim 13, wherein the predetermined condition is an acceptance or a rejection of the buyer response.

16. The system of claim 13, wherein the predetermined condition is an acceptance or a rejection of the seller response.

17. The system of claim 13, wherein the predetermined condition is an expiration of the buyer and/or seller response.

18. A system for creating an online advertising marketplace where buyers and sellers are brought together based on common advertising needs, the system comprising one or more processing devices collectively configured to:
receive specifications for desired advertising spots from one or more buyers;
receive postings of available advertising inventory from one or more sellers;
execute a comparison algorithm that compares the specifications for desired advertising spots with the postings of available advertising inventory, wherein the comparison algorithm generates a set of results;
make the set of results available to a buyer; and
enable a buyer to purchase advertising inventory from a seller based on the buyer selecting at least one of the set of results.

19. The system of claim 18, the one or more processing devices further configured to:
send an alert to at least one seller when a specification for desired advertising spots is received; and
enable the at least one seller to submit available advertising inventory that matches the specification in response to the alert.

20. The system of claim 18, wherein buyers enter specifications and sellers enter submissions into an online application.

21. A computer-readable medium containing computer-executable instructions for selling advertising spots online, the computer-executable instructions collectively configured to:
receive, from a buyer, at least one request to purchase an advertising spot, wherein the at least one requests includes criteria describing the requested spot;
receive, from a seller, an inventory of at least one available advertising spot, wherein the inventory includes criteria describing the at least one available spot;
correlate the request criteria and the inventory criteria to identify at least one match;
receive, from the buyer, an offer to purchase the at least one match; and
complete a transaction for the at least one match when a predetermined condition is met.

22. The computer-readable medium of claim 21, wherein the offer comprises a bid on the at least one match, the bid including criteria that modifies at least part of the criteria describing the at least one match.

23. The computer-readable medium of claim 22, the computer-executable instructions further collectively configured to process at least one negotiation round, the negotiation round comprising the steps of:
receiving, from the seller, a response to the bid, wherein the response is one of an acceptance, a rejection, or a counter-offer to the bid; and
receiving, from the buyer, a response to the seller response, wherein the buyer response is one of an acceptance, a rejection, or a counter-offer to the seller response.

24. The computer-readable medium of claim 23, wherein the predetermined condition is met after a predetermined number negotiation rounds.

25. The computer-readable medium of claim 23, wherein the predetermined condition is an acceptance or a rejection of the buyer response.

26. The computer-readable medium of claim 23, wherein the predetermined condition is an acceptance or a rejection of the seller response.

27. The computer-readable medium of claim 23, wherein the predetermined condition is an expiration of the buyer and/or seller response.

28. A computer-readable medium containing one or more computer-executable instructions for creating an online advertising marketplace where buyers and sellers are brought together based on common advertising needs, the computer-executable instructions collectively configured to:
receive specifications for desired advertising spots from one or more buyers;
receive postings of available advertising inventory from one or more sellers;
execute a comparison algorithm that compares the specifications for desired advertising spots with the postings of available advertising inventory, wherein the comparison algorithm generates a set of results;
make the set of results available to a buyer; and
enable a buyer to purchase advertising inventory from a seller based on the buyer selecting at least one of the set of results.

29. The computer-readable medium of claim 28, the computer-executable instructions further collectively configured to:
send an alert to at least one seller when a specification for desired advertising spots is received; and
enable the at least one seller to submit available advertising inventory that matches the specification in response to the alert.

30. The computer-readable medium of claim 28, wherein buyers enter specifications and sellers enter submissions into an online application.
